(19) United States
(12) Patent Application Publication
(10) Pub. No.: US 2006/0078061 A1
(43) Pub. Date: Apr. 13, 2006

(54) Likelihood calculating method and communication method

(75) Inventor: Koji Horisaki, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/240,465

(22) Filed: Oct. 3, 2005

(30) Foreign Application Priority Data
Oct. 13, 2004 (JP) 2004-298995

(51) Int. Cl. H04L 5/12; H04B 7/02

(52) U.S. Cl. 375/261; 375/267

(57) ABSTRACT

A likelihood calculating method, which uses a receiver having information data of plural signal points based on predefined data which consist of plural bits transmitted from a transmitter, comprises: receiving a reception signal from the transmitter; selecting a first signal point which, among the plural signal points, is the shortest distance from the reception signal in a phase plane; calculating a first distance in the phase plane between the first signal point and the reception signal, and calculating a second distance in the phase plane between a second signal point corresponding to a signal obtained by inverting one of bits of the first signal point, and the reception signal; and calculating the difference between the first and second distances and using the result of calculation as a likelihood indicative of certainty of the bit in the reception signal.

### CROSS-REFERENCE TO RELATED APPLICATIONS

This application is based upon and claims the benefit of priority from the prior Japanese Patent Applications No. 2004-298995, filed on Oct. 13, 2004, the entire contents of which are incorporated herein by reference.

### BACKGROUND OF THE INVENTION

1. Field of the Invention

The present invention relates to a likelihood calculating method and a communication method.

2. Background Art

A digital communication system using plural antennas such as a wireless LAN system and a baseband LSI as a component of the wireless LAN system transmits/receives information data. The information data is data consisting of plural bits transmitted from a transmitter to a receiver. The receiver receives the information data sent from the transmitter and estimates each of the bits of the information data. The information data is estimated by comparing signal points defined before communications by the receiver with a reception signal. Usually, a signal point which is the closest to the reception signal is estimated as information data. The estimation of the information data is performed by, for example, a suboptimum decoding algorithm (refer to “Achieving Near-Capacity on a Multiple-Antenna Channel” by Hochwald, IEEE Transactions on Communications, Vol. 51, No. 3, March 2003 (Non-Patent Document 1)). The distance in a phase plane between a reception signal and estimated information data is set as “distance 1”.

Next, the receiver calculates likelihood of each of the bits of the estimated information data. The likelihood is a parameter indicative of certainty of match between the estimated information data and transmitted information data. Hitherto, to calculate the likelihood of a bit in estimated information data, the receiver inverts the bit and calculates distances in a phase plane between all other signal points and the reception signal. Each of the all other signal points has a same bit as the inverted bit of the estimated information data and has other bits different from the bits other than the inverted bit of the estimated information data. For example, in the case of calculating the likelihood of the first bit in estimated information data (0000), distances in the phase plane between eight signal points (1000) to (1111) and a reception signal are calculated and the signal point in the shortest distance among the distances is selected. The shortest distance is set as “distance 2”. The likelihood of the first bit in the estimated information data (0000) corresponds to the difference between the distances 1 and 2 (Non-Patent Document 1).

In the conventional likelihood calculating method, however, a lot of distances between a number of signal points and a reception signal in a phase plane have to be calculated. Therefore, the computation cost of likelihood calculation is high and, further, the throughput of communication is low.

### SUMMARY OF THE INVENTION

A likelihood calculating method according to an embodiment of the present invention, which method is used in a receiver having information data of plural signal points based on predefined data which consist of plural bits transmitted from a transmitter, comprises: receiving a reception signal from the transmitter; selecting a first signal point which, among the plural signal points, is the shortest distance from the reception signal in a phase plane; calculating a first distance in the phase plane between the first signal point and the reception signal, and calculating a second distance in the phase plane between a second signal point corresponding to a signal obtained by inverting one of bits of the first signal point and the reception signal; and calculating the difference between the first and second distances and using the result of calculation as a likelihood indicative of certainty of the bit in the reception signal.

A likelihood calculating method according to another embodiment of the present invention, which method is used in a receiver having information data of plural signal points based on predefined data which consist of plural bits transmitted from a transmitter, comprises: receiving a reception signal from the transmitter; selecting a first signal point which, among the plural signal points, is the shortest distance from the reception signal in a phase plane; calculating a square of a first distance in the phase plane between the first signal point and the reception signal, and calculating a square of a second distance in the phase plane between a second signal point corresponding to a signal obtained by inverting one of bits of the first signal point and the reception signal; and calculating the difference between the square of the first distance and the square of the second distance and using the result of calculation as a likelihood of the bit in the reception signal.

A likelihood calculating method according to further embodiment of the present invention, which method is used in a receiver having information data of plural signal points based on predefined data which consist of plural bits transmitted from a transmitter and the receiver comprising a first and a second reception antennas, comprises: receiving reception signals from the transmitter by each of the first and second reception antennas; selecting a first signal point which, among the plural signal points, has the smallest sum of a distance from a reception signal of the first reception antenna in the phase plane and a distance from a reception signal of the second reception antenna in the phase plane, with respect to each of the first and second reception antennas; calculating a first distance sum of the distance in the phase plane between the reception signal of the first reception antenna and the first signal point, and the distance in the phase plane between the reception signal of the second reception antenna and the first signal point; calculating a second distance sum of the distance in the phase plane between a second signal point corresponding to a signal obtained by inverting one of bits of the first signal point and the reception signal of the first reception antenna, and the distance in the phase plane between the second signal point and the reception signal of the second reception antenna; and calculating the difference between the first and second distance sums and using the result of calculation as a likelihood indicative of certainty of the bit in the reception signal.

A likelihood calculating method according to further embodiment of the present invention, which method is used in a receiver having information data of plural signal points based on predefined data which consist of plural bits transmitted from a transmitter and the receiver comprising a first and a second reception antennas, comprises: receiving reception signals from the transmitter by each of the first and second reception antennas; selecting a first signal point which, among the plural signal points, has the smallest sum of a square of a distance from a reception signal of the first reception antenna in the phase plane and a square of a distance from a reception signal of the second reception antenna in the phase plane, with respect to each of the first and second reception antennas; calculating a first sum of the square of the distance in the phase plane between the reception signal of the first reception antenna and the first signal point, and the square of the distance in the phase plane between the reception signal of the second reception antenna and the first signal point; calculating a second sum of the square of the distance in the phase plane between a second signal point corresponding to a signal obtained by inverting one of bits of the first signal point and the reception signal of the first reception antenna, and the square of the distance in the phase plane between the second signal point and the reception signal of the second reception antenna; and calculating the difference between the first and second sums and using the result of calculation as a likelihood indicative of certainty of the bit in the reception signal.

A likelihood calculating method according to further embodiment of the present invention, which method is used in a receiver having information data of plural signal points based on predefined data which consist of plural bits transmitted from a transmitter, comprises: receiving a reception signal from the transmitter; selecting a first signal point which, among the plural signal points, is the shortest distance from the reception signal in a phase plane; calculating a first distance in the phase plane between the first signal point and the reception signal, and calculating a second distance in the phase plane between a second signal point corresponding to a signal obtained by inverting one of bits of the first signal point and the reception signal; calculating the difference between the first and second distances and using the result of calculation as a likelihood indicative of certainty of the bit in the reception signal; and changing one or more of a transmission power, a modulating method and a coding rate of the transmitter on the basis of an average of the likelihoods of the bits of the reception signal.

### BRIEF DESCRIPTION OF THE DRAWINGS

FIG. 1 is a configuration diagram of a communication system 100 according to a first embodiment of the invention;

FIG. 2 is a diagram showing a state, in which information data is transmitted from the transmitter 101 to the receiver 104, by using a phase space;

FIG. 3 is a configuration diagram of a communication system 200 according to a second embodiment of the invention;

FIG. 4 is a diagram showing signal points and reception signals in the phase plane in the first and second antennas 205 and 206;

FIG. 5 is a configuration diagram of a communication system 300 according to a third embodiment of the invention;

FIG. 6 is a diagram showing the signal points of the information data transmitted from the transmission antenna in the phase plane;

FIG. 7 is a diagram in which the signal points in the reception antenna 105 and reception signals are shown in the phase plane; and

FIG. 8 is a diagram showing the configuration of a communication system 500 of a fifth embodiment according to the invention.

### DETAILED DESCRIPTION OF THE INVENTION

Embodiments of the invention will be described below with reference to the drawings. The invention is not limited to the embodiments.

### FIRST EMBODIMENT

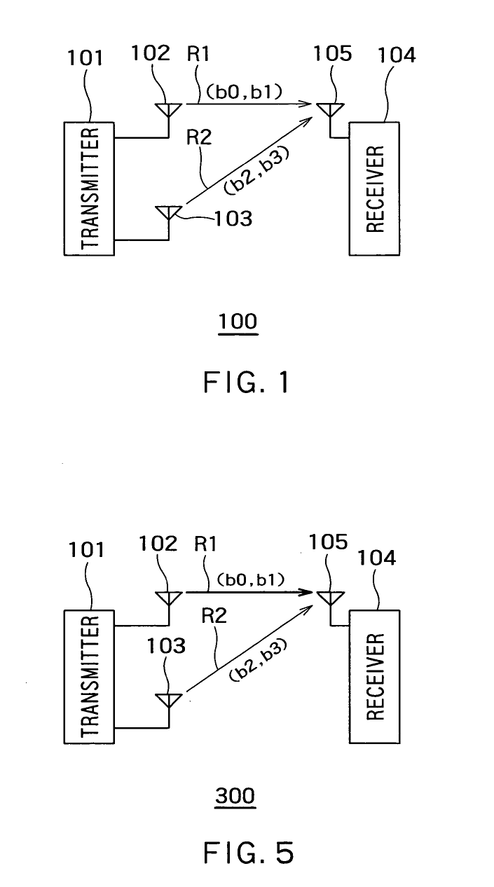

FIG. 1 is a configuration diagram of a communication system 100 according to a first embodiment of the invention. The communication system 100 has a transmitter 101 and a receiver 104. The transmitter 101 has transmission antennas 102 and 103. The receiver 104 has a reception antenna 105. The transmitter 101 transmits 2-bit information data (b0, b1) and (b2, b3) from the two transmission antennas 102 and 103. The receiver 104 receives the information data (b0, b1) and (b2, b3) by the reception antenna 105. The information data (b0, b1) and information data (b2, b3) is spatial-combined in a transmission path extending from the transmitter 101 to the receiver 104. Therefore, the receiver 104 receives the information data (b0, b1) and (b2, b3) as 4-bit information data (b0, b1, b2, b3). Each of b0 to b3 indicates a bit.

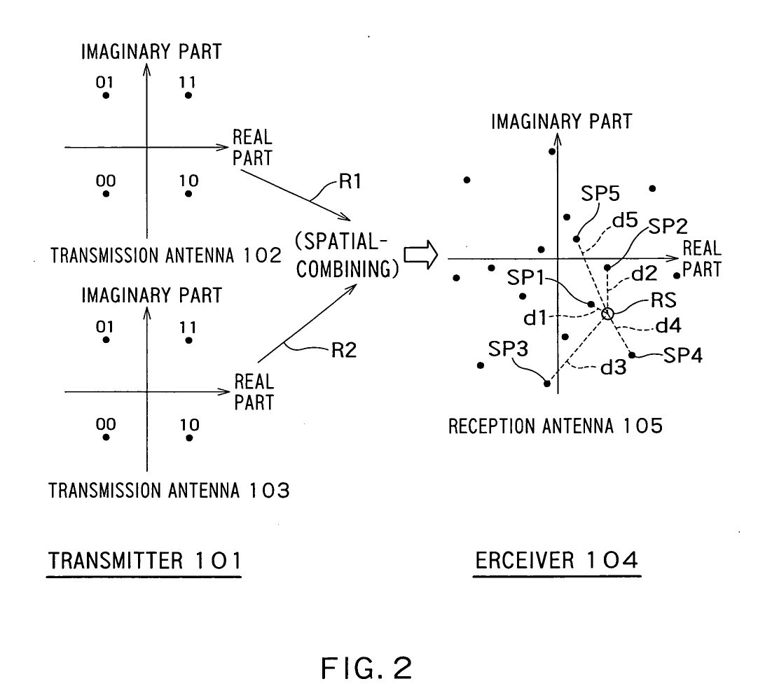

FIG. 2 is a diagram showing a state, in which information data is transmitted from the transmitter 101 to the receiver 104, by using a phase space. The transmitter 101 transmits 2-bit information data (b0, b1) and 2-bit information data (b2, b3) from the transmission antennas 102 and 103, respectively. That is, the transmitter 101 transmits any of information data (0, 0), (0, 1), (1, 0), and (1, 1) from each of the transmission antennas 102 and 103.

The receiver 104 receives predefined data, for example, a preamble sent from the transmitter 101 and preliminarily obtains signal points corresponding to the 4-bit information data on the basis of the predefined data. In the first embodiment, since the information data is four bits, 16 signal points are obtained.

The receiver 104 receives the information data sent from the transmitter 101. Generally, a transmission path R1 extending from the transmission antenna 102 to the receiver 104 and a transmission path R2 from extending from the transmission antenna 103 to the receiver 104 are different from each other. Further, the space states in the transmission paths R1 and R2 changes with time. Therefore, when the spatially-combined information data is received by the receiver 104, in many cases, the information data does not match any of the 16 signal points of the receiver 104. Particularly, in the case where the transmitter 101 or receiver 104 is a portable electronic device, this tendency is conspicuous.

Therefore, the receiver 104 estimates the 4-bit information data sent from the transmitter 101 on the basis of a reception signal RS. For example, among the 16 signal points, a signal point SP1 is a signal point corresponding to information data (0,0,0,0), a signal point SP2 is a signal point corresponding to information data (1,0,0,0), a signal point SP3 is a signal point corresponding to information data (0,1,0,0), a signal point SP4 is a signal point corresponding to information data (0,0,1,0), and a signal point SP5 is a signal point corresponding to information data (0,0,0,1). The receiver 104 selects the first signal point which is the closest to the reception signal RS in the phase plane as a result of estimation of the information data, that is, as estimated information data. For example, in the first embodiment, the first signal point SP1 is selected as estimated information data. Therefore, the estimated information data (b0, b1, b2, b3) is estimated as (0,0,0,0). As the information data estimating method, the suboptimum decoding algorithm may be used.

Next, the receiver 104 calculates likelihood of each of the bits of the estimated information data (first signal point). The embodiment utilizes the fact that the signal point obtained by inverting any one of the bits of the estimated information data is close to the estimated information data. For example, in the case of calculating likelihood of the bit b0, the bit b0 is inverted. Specifically, (b0,b1,b2,b3) becomes (1,0,0,0) which corresponds to the second signal point SP2. The distance in the phase plane between the first signal point SP1 and the reception signal is set as first distance d1, and the distance in the phase plane between the second signal point SP2 and the reception signal is set as second distance d2. The receiver 104 computes the difference between the first and second distances d1 and d2 as the likelihood of the bit b0.

With respect to the bits b1 to b3, the receiver 104 calculates the likelihood in a manner similar to the computation on the bit b0. The receiver 104 inverts the bits b1 to b3 to calculate the likelihood of the bits b1 to b3, respectively. Therefore, the likelihood of the bit b1 becomes the difference between the distances d1 and d3. The likelihood of the bit b2 is the difference between the distances d1 and d4. The likelihood of the bit b3 is the difference between the distances d1 and d5. In such a manner, the receiver 104 can calculate the likelihood of each of the bits of the estimated information data.

According to the conventional method, the receiver 104 has to calculate the distances in the phase plane between the eight signal points (1000) to (1111) and the reception signal in order to obtain the likelihood of the bit b0. Further, the receiver 104 has to compare the eight distances to calculate the shortest distance.

In the first embodiment, however, the receiver 104 calculates only the distance in the phase plane between one signal point (1000) and the reception signal in order to obtain the likelihood of the bit b0. Therefore, the receiver 104 does not have to compare the distances to the plural signal points at the time of calculating the shortest distance. It means that the computation cost of the likelihood calculation can be reduced. Since the receiver 104 can calculate the likelihood in relatively short time, the throughput of communication improves.

In the first embodiment, in place of the distances d1, d2, d3, d4, and d5, the squares d1², d2², d3², d4², and d5² of the distances may be also used.

### SECOND EMBODIMENT

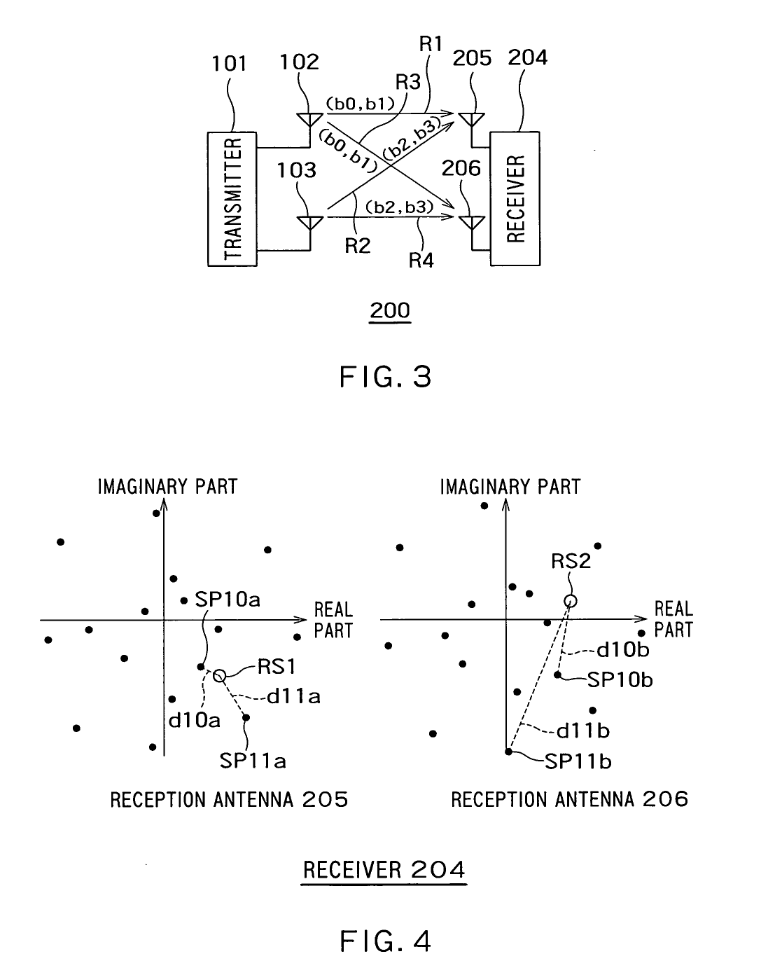

FIG. 3 is a configuration diagram of a communication system 200 according to a second embodiment of the invention. The communication system 200 has a transmitter 101 and a receiver 204. Since the transmitter 101 is the same as the transmitter 101 in the first embodiment, its description will not be repeated. The receiver 204 has a first reception antenna 205 and a second reception antenna 206. Consequently, there are four transmission paths R1 to R4 of information data. Each of the first and second reception antennas 205 and 206 receivers 4-bit information data (b0,b1,b2,b3).

FIG. 4 is a diagram showing signal points and reception signals in the phase plane in the first and second antennas 205 and 206. The receiver 204 receives predefined data, for example, a preamble sent from the transmitter 101 and preliminarily obtains signal points corresponding to the 4-bit information data on the basis of the predefined data.

In the second embodiment, each of the first and second reception antennas 205 and 206 receives predefined data. Therefore, as shown in FIG. 4, 16 signal points are obtained for each of the first and second reception antennas 205 and 206.

The receiver 204 receives the information data sent from the transmitter 101. Further, the receiver 204 estimates information data on the basis of a reception signal RS1 received by the first reception antenna 205 and a reception signal RS2 received by the second reception antenna 206. More specifically, the receiver 204 calculates the distance between the reception signal RS1 and a signal point corresponding to certain information data in the phase plane with respect to the first reception antenna 205 and calculates the distance between the reception signal RS2 and a signal point corresponding to the information data in the phase plane with respect to the second reception antenna 206. The receiver 204 selects the first signal point having the smallest sum of the distances as estimated information data. The estimation can be performed by applying the distance sum to a suboptimum decoding algorithm means.

For example, in the phase planes for each of the first and second reception antennas 205 and 206, signal points SP10a and SP10b are signal points corresponding to information data (0,0,0,0). Reception signals of the first and second reception antennas 205 and 206 are indicated by RS1 and RS2, respectively. At this time, the receiver 204 calculates distance d10a between the reception signal RS1 and the signal point SP10a corresponding to the information data (0,0,0,0) on the phase plane of the first antenna 205. The receiver 204 calculates distance d10b between the reception signal RS2 and the signal point SP10b corresponding to the information data (0,0,0,0) on the phase plane of the second antenna 206. Next, the receiver 204 calculates the sum of the distances d10a and d10b (hereinbelow, also called “distance sum”). The receiver 204 compares the “distance sum” with “distance sum” of other information data. Further, the receiver 204 selects information data having the smallest distance sum as estimated information data. At this time, the suboptimum decoding algorithm may be used.

At the time of calculating the likelihood of each of the bits of the estimated information data (first signal point), distance sum of each information data is used. For example, in the case of calculating the likelihood of the bit b0 in the estimated information data (0,0,0,0), the bit b0 is inverted. That is, (b0,b1,b2,b3) becomes (1,0,0,0). The distance sum (d10a+d10b) with respect to the information data (0,0,0,0) is set as first distance sum, and the distance sum (d11a+d11b) with respect to the information data (1,0,0,0) is set as second distance sum. The receiver 204 calculates the difference (|(d11a+d11b)−(d10a+d10b)|) between the first and second distance sums as the likelihood of the bit b0. The receiver 204 calculates the likelihood of each of the bits b1 to b3 in a manner similar to the calculation of the bit b0. The distance d11a is the distance between the signal point SP11a and the reception signal RS1, and the distance d11b is the distance between the signal point S11b and the reception signal RS2. Each of the signal points corresponds to the information data (1,0,0,0,0).

In the second embodiment, to obtain the likelihood of a bit in estimated information data, it is sufficient to calculate the difference between the distance sum related to the estimated information data and the distance sum related to another piece of information data. Therefore, the receiver 204 does not have to compare a plurality of distances at the time of calculating the shortest distance. It means that the computation cost of the likelihood calculation can be reduced. Since the receiver 204 can calculate the likelihood in relatively short time, the throughput of communication improves.

Although the “distance sum” of information data is used in the second embodiment, instead, “sum of squares of distances” may be used. For example, sum of squares of distances related to the information data (0,0,0,0) is the sum of the square of the distance d10a and the square of the distance d10b.

In the second embodiment, the receiver 204 has two reception antennas 205 and 206. Alternately, the receiver 204 may have three or more reception antennas. In this case, 16 signal points are obtained for each of the three or more antennas on the phase plane. As the “distance sum”, it is sufficient to obtain the sum of distances between the signal points in each of the three or more phase planes and a reception signal.

### THIRD EMBODIMENT

FIG. 5 is a configuration diagram of a communication system 300 according to a third embodiment of the invention. The communication system 300 has a transmitter 101 and a receiver 104. Since the configurations of the transmitter 101 and receiver 104 are the same as those in the first embodiment, their description will not be repeated.

In the third embodiment, the receiver 104 selects a bit to be subjected to likelihood calculation on the basis of the magnitudes of reception powers of signals from transmission antennas 102 and 103. The magnitude of reception power can be detected by the preamble of a transmission signal. For example, when the reception power of information data (b0,b1) transmitted from the transmission antenna 102 is relatively high, the receiver 104 determines that the reliability of the bits b0 and b1 in estimated information data (first signal point) is high and maximizes the likelihood of the bits b0 and b1. In this case, the receiver 104 does not have to calculate likelihood.

On the other hand, when the reception power of information data (b2, b3) transmitted from the transmission antenna 103 is relatively low, the receiver 104 calculates the likelihood of the bits b2 and b3 in the estimated information data. At this time, as the likelihood calculating method, any of the likelihood calculating methods in the first and second embodiments may be used.

As a modification of the third embodiment, a threshold bay be set for the reception power. When average reception power of a bit is higher than the threshold, the receiver 104 may set a constant (for example, the maximum likelihood) as the likelihood of the bit. When the reception power of a bit is lower than the threshold, the receiver 104 calculates the likelihood of the bit.

It is also possible to set plural thresholds for the reception power and set a constant as the likelihood for each of the thresholds. When the reception power of a bit is higher than a threshold, the receiver 104 sets a constant corresponding to the threshold as the likelihood of the bit.

According to the third embodiment, the computation cost of likelihood calculation can be further reduced. Since the receiver 104 can calculate the likelihood in shorter time, the throughput of communication improves.

Although the receiver 104 has one reception antenna 105 in FIG. 5, the number of reception antennas may be two or more. In this case, the receiver 104 selects a bit to be subjected to likelihood calculation on the basis of the magnitude of average reception power of signals from the transmission antennas 102 and 103. The average reception power is an average value of reception powers of the plural reception antennas for receiving signals from a transmission antenna (for example, the transmission antenna 102).

The number of transmission antennas in the transmitter 101 may be three or more. In this case, the average reception power is calculated for all of the transmission antennas. It is sufficient for the receiver 104 to perform likelihood calculation only on a bit transmitted from “n” transmission antennas (n denotes a constant smaller than the number of transmission antennas) of the lowest reception power.

### FOURTH EMBODIMENT

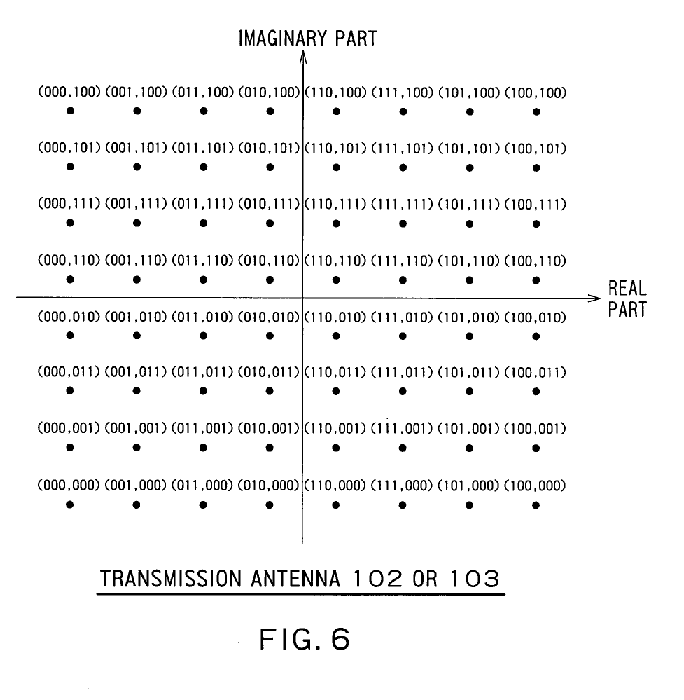

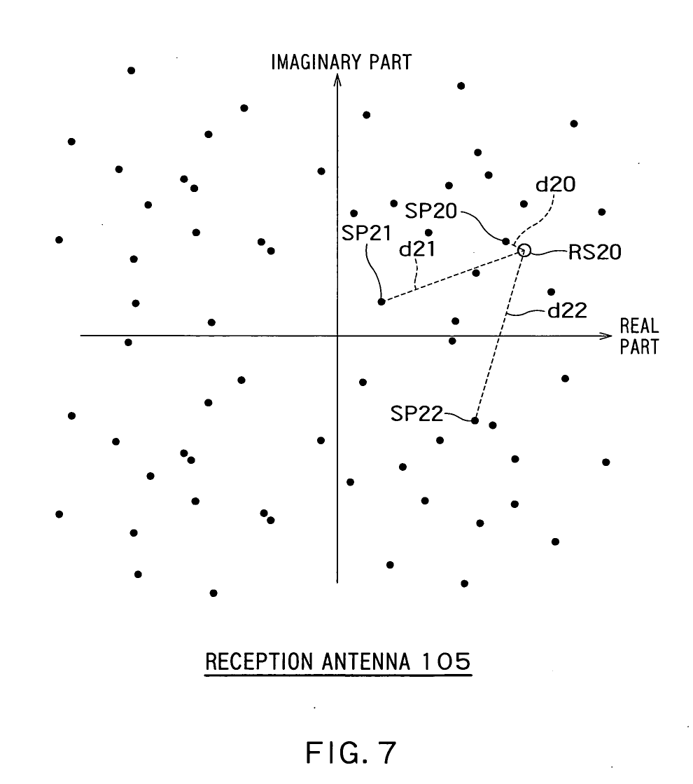

FIGS. 6 and 7 are diagrams showing a likelihood calculating method of a fourth embodiment according to the invention. The configuration of a communication system according to the fourth embodiment may be similar to that of FIG. 1 except that, in the fourth embodiment, a communication system uses a modulating method called 64QAM (Quadrate Amplitude Modulation). Therefore, information data is constructed by a real part of three bits and an imaginary part of three bits. The former three bits in numerical values in parentheses in FIG. 6 correspond to the real part of information data and the latter three bits correspond to the imaginary part of the information data. A signal point of the information data is shown below the numerical values in the parentheses.

The transmitter 101 has two transmission antennas 102 and 103 (refer to FIG. 1). Each of the transmission antennas 102 and 103 sends information data of six bits. Therefore, the receiver 104 receives information data of total 12 bits.

FIG. 7 is a diagram in which the signal points in the reception antenna 105 and reception signals are shown in the phase plane. Since it is difficult to show all of signal points (4096 signal points) corresponding to information data of 12 bits, signal points corresponding to part of the information data of 12 bits are shown.

In a manner similar to the first embodiment, the receiver 104 selects a first signal point SP20 closest to a reception signal RS20 as estimated information data. It is assumed that the first signal point SP20 is a signal point of information data (1, 1, 1, 0, 0, 0, 0, 0, 0, 0, 0, 0). At this time, estimated information data (b0, b1, b2, b3, b4, b5, b6, b7, b8, b9, b10, b11) becomes (1, 1, 1, 0, 0, 0, 0, 0, 0, 0, 0, 0). The distance between the reception signal RS20 and the first signal point SP20 is set as d20.

After that, the receiver 104 calculates the likelihood of a signal transmitted from the transmission antenna 102. Calculation of the likelihood of the real part is executed by using signal points adjacent to each other in the axial direction of the real part of the first signal point SP20. Calculation of the likelihood of the imaginary part is executed by using the signal points adjacent to each other in the axial direction of the imaginary part of the first signal point SP20. For example, the likelihood of the real part (b0, b1, b2)=(1,1,1) is calculated. In this case, the signal points adjacent to each other in the axial direction of the real part of the first signal point SP20 are a signal point (0, 1, 1, 0, 0, 0, 0, 0, 0, 0, 0, 0) and a signal point (1, 1, 0, 0, 0, 0, 0, 0, 0, 0, 0, 0) (refer to FIG. 6). The signal point (0, 1, 1, 0, 0, 0, 0, 0, 0, 0, 0, 0) is a signal point obtained by inverting the bit b0 of the first signal point SP20 and is set as SP21. The signal point (1, 1, 0, 0, 0, 0, 0, 0, 0, 0, 0, 0) is a signal point obtained by inverting the bit b2 in the first signal point SP20 and is set as SP22.

The receiver 104 calculates a distance d21 between the reception signal RS20 and the signal point SP21, and a distance d22 between the reception signal RS20 and the signal point SP22. Then, the receiver 104 sets the difference between the distances d20 and d21 as the likelihood of the bit b0, and sets the difference between the distances d20 and d22 as the likelihood of the bit b2. The likelihood of the bit b1 is larger one of the likelihood of the bit b0 and the likelihood of the bit b2 since the reliability of the bit b1 is usually higher than that of the bits b0 and b2.

The receiver 104 calculates the likelihood of the imaginary part (b3, b4, b5) of a signal transmitted from the transmission antenna 102, the likelihood of the real part (b6, b7, b8) of a signal transmitted from the transmission antenna 103, and the likelihood of the imaginary part (b9, b10, b11) of a signal transmitted from the transmission antenna 103 in a manner similar to the calculation of the likelihood of (b0, b1, b2). It should be noted that, as described above, calculation of the likelihood of the imaginary part is executed by using signal points adjacent to each other in the axial direction of the imaginary part of the first signal point SP20. The likelihood of each of the bits of the estimated information data is calculated as described above.

The fourth embodiment has effects similar to those of the first embodiment. In addition, according to the fourth embodiment, the receiver 104 does not have to calculate the likelihoods of ⅓ of the number of bits of the estimated information data, that is, four bits out of 12 bits. Therefore, the computation cost of likelihood calculation is further reduced and the likelihood can be calculated in shorter time.

### FIFTH EMBODIMENT

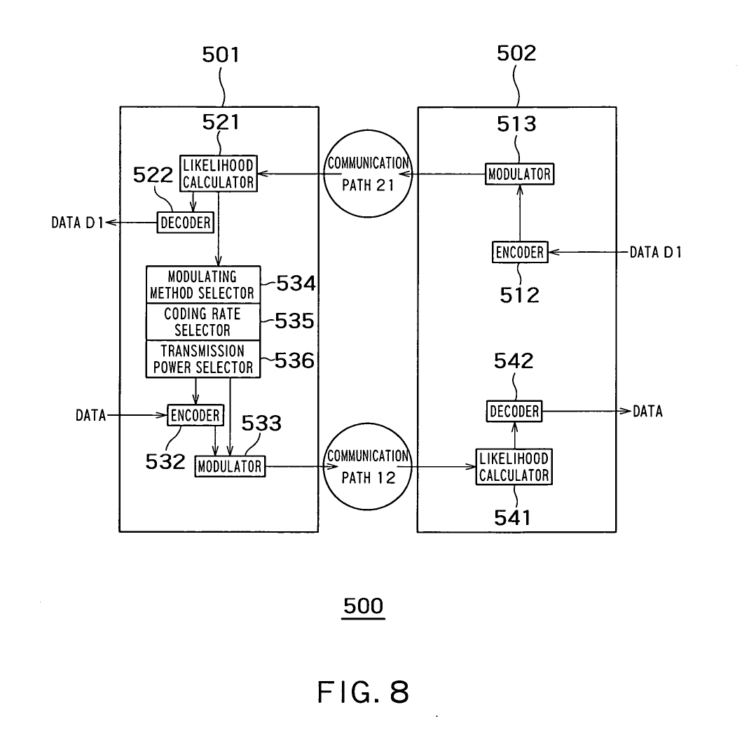

FIG. 8 is a diagram showing the configuration of a communication system 500 of a fifth embodiment according to the invention. The communication system 500 has communication devices 501 and 502. The communication devices 501 and 502 can perform communications with each other via communication paths 12 and 21.

Each of the communication paths 12 and 21 is a collection of plural transmission lines for coupling plural transmission antennas and plural reception antennas so as to be able to perform communications. The communication paths 12 and 21 may be the same communication path or separate communication paths.

The communication device 502 performs error correction coding on data D1 in an encoder 512. A modulator 513 converts the encoded data D1 to a signal in a form adapted to the communication path 21. Next, the communication device 502 transmits the data D1 to the communication device 501 via the communication path 21. The communication device 501 receives the data D1 from the communication path 21 and demodulates the data D1.

A likelihood calculator 521 selects estimated information data on the basis of a reception signal of the data D1 by using any of the methods of the first to fourth embodiments. The estimated information data is decoded by a decoder 522 and the decoded data is output to the outside. The likelihood calculator 521 calculates the likelihood of each of the bits of the estimated information data by using any of the methods of the first to fourth embodiments. Further, the likelihood calculator 521 calculates an average value of likelihoods of the bits of the estimated information data. The likelihood calculator 521 outputs the average likelihood to at least one of a modulating method selector 534, a coding rate selector 535, and a transmission power selector 536.

The modulating method selector 534 changes the modulating method of the communication device 502 on the basis of the average likelihood. For example, in the case where the average likelihood is larger than a predetermined threshold, the modulating method selector 534 selects a modulating method of a large transmission amount. In the case where the average likelihood is smaller than the predetermined threshold, the modulating method selector 534 selects a modulating method of a small transmission amount. The information of the modulating method is transmitted to the communication device 502 via the transmission path 12. The communication devices 501 and 502 perform communications in accordance with the modulating method.

The modulating method is, for example, BPSK (Binary Phase Shift Keying), QPSK (Quadrate Phase Shift Keying), 16QAM, 64QAM, or the like. The BPSK, QPSK, 16QAM, and 64QAM are listed in order of increasing transmission speed. The BPSK, QPSK, 16AM, and 64QAM are listed in order of decreasing resistance to distortion and noise.

Generally, the modulating method of a small transmission amount is resistive to distortion and noise in the transmitter, receiver, and communication path. On the contrary, the modulating method of a large transmission amount is vulnerable to distortion and noise. In the case where distortion and noise exists, a reception error tends to occur.

In the embodiment, in the case where distortion and noise is small, the modulating method in which resistance to distortion and noise is low but the transmission amount is large is selected. On the other hand, in the case where distortion and noise is large, the modulating method in which the transmission amount is small but resistance to distortion and noise is high can be selected. In such a manner, the throughput of communications between the communication devices 501 and 502 improves.

The coding rate selector 535 selects the coding rate of the encoder 512 on the basis of the average likelihood. For example, when the average likelihood is larger than the predetermined threshold, the coding rate selector 535 selects a high coding rate. When the average likelihood is smaller than the predetermined threshold, the coding rate selector 535 selects a low coding rate. The information of the coding rate is transmitted to the communication device 502 in a manner similar to the modulating method. The communication devices 501 and 502 perform communications in accordance with the coding rate and the modulating method.

As the encoding method, for example, a convolutional coding system is often employed in a communication system. In this case, as coding rates, for example, 1/2, 2/3, and ¾ are often used. The data transmission amounts of 1/2, 2/3, and ¾ are listed in increasing order. The resistances to distortion and noise of 1/2, 2/3, and ¾ are listed in decreasing order.

Generally, a high coding rate denotes a large data transmission amount. However, data encoded at a high coding rate is vulnerable to distortion and noise, so that a reception error tends to occur. On the other hand, a low coding rate denotes a small data transmission amount. However, data encoded at a low coding rate is resistive to distortion and noise, so that occurrence of a reception error is suppressed.

In the embodiment, when distortion and noise is small, a coding rate at which resistance to distortion and noise is low but the transmission amount is large is selected. On the other hand, in the case where distortion and noise is large, a coding rate at which the transmission amount is small but resistance to distortion and noise is high can be selected. In such a manner, the throughput of communications between the communication devices 501 and 502 improves.

The transmission power selector 536 changes transmission power on the basis of the average likelihood. For example, when the average likelihood is larger than the predetermined threshold, the transmission power selector 536 selects low transmission power. When the average likelihood is larger than the predetermined threshold, the transmission power selector 536 selects high transmission power. The information of the transmission power is transmitted to the communication device 502 via the communication path 12. The communication devices 501 and 502 adjust the transmission power in accordance with the information.

Generally, when the transmission power is low, the power consumption of the communication device is low and the SNR (Signal to Noise Ratio) in the receiver is low. When the SNR is low, a reception error tends to occur. On the other hand, when the transmission power is high, the SNR in the receiver is high but power consumption in the transmitter is large. In the case where the transmission power is excessively high, there is the possibility that interference to another communication station or another communication system increases. Consequently, it is preferable to set the transmission power as low as possible within the range where occurrence of a reception error is suppressed.

In the embodiment, by selecting the transmission power on the basis of the average likelihood, the transmission power which is as low as possible can be selected within the range where occurrence of a reception error is suppressed.

The communication device 501 may individually select the modulating method, coding rate, and transmission power. Alternately, the communication device 501 may select a combination of two or more of the modulating method, coding rate, and transmission power. For example, the modulating method of BPSK, the coding rate of ½, and transmission power of −10 dBm are set as combination A, the modulating method of QPSK, the coding rate of ¾, and the transmission power of −15 dBm are set as combination B, and the modulating method of 64 QAM, the coding rate of ⅔, and the transmission power of −20 dBm are set as combination C. A threshold 1 for distinguishing the combinations A and B from each other, and a threshold 2 for distinguishing the combinations B and C from each other are preliminarily set. The threshold 2 is larger than the threshold 1. The communication device 501 can select the combination C when the average likelihood larger the threshold 2, can select the combination B when the average likelihood is equal to or larger than the threshold 1 and equal to or smaller than the threshold 2, and can select the combination A when the average likelihood is less than the threshold 1.

As described above, when the modulating method, cording rate, and transmission power are selected in any of the combinations, the configuration of the communication device 501 can be simplified. Further, in the case where the communication device 502 pre-stores the combinations of the modulating system, coding rate, and transmission power, it is sufficient for the communication device 501 to notify of the information indicative of the combination (for example, the combination A, B, or C). Therefore, the amount of information from the communication device 501 to the communication device 502 can be reduced. As a result, the throughput of communication between the communication devices 501 and 502 improves.

Preferably, the transmission characteristics of the communication paths 12 and 21 are the same or similar to each other, and the coding methods of the communication devices 501 and 502 are the same or similar to each other. Therefore, the communication devices 501 and 502 can select the modulating method, coding rate, and transmission power in a lump.

The foregoing embodiments can be generally applied to digital communication systems each using plural antennas. In particular, the embodiments can be applied to a wireless LAN system and a baseband LSI as a component of a wireless LAN system.

What is claimed is:

1. A likelihood calculating method, which is used in a receiver having information data of plural signal points based on predefined data which consist of plural bits transmitted from a transmitter, comprising:
receiving a reception signal from the transmitter;
selecting a first signal point which, among the plural signal points, is the shortest distance from the reception signal in a phase plane;
calculating a first distance in the phase plane between the first signal point and the reception signal, and calculating a second distance in the phase plane between a second signal point corresponding to a signal obtained by inverting one of bits of the first signal point and the reception signal; and
calculating the difference between the first and second distances and using the result of calculation as a likelihood indicative of certainty of the bit in the reception signal.

2. The likelihood calculating method according to claim 1, wherein
the first signal point is selected by using a suboptimum decoding algorithm.

3. The likelihood calculating method according to claim 1, wherein
a likelihood is calculated for each bit included in the first signal point.

4. The likelihood calculating method according to claim 1, wherein
the second signal point corresponds to a signal obtained by inverting a bit which has a low reception power among bits in the first signal point,
wherein a likelihood of a bit which has a large reception power among bits in the first signal point is constant.

5. The likelihood calculating method according to claim 1, wherein
the second signal point corresponds to a signal obtained by inverting a bit which has a lowest average reception power among bits in the first signal point,
wherein a likelihood of a bit which has a largest average reception power among bits in the first signal point is the maximum likelihood in the receiver.

6. The likelihood calculating method according to claim 2, wherein
the second signal point corresponds to a signal obtained by inverting a bit which has a lowest average reception power among bits in the first signal point,
wherein a likelihood of a bit which has a largest average reception power among bits in the first signal point is the maximum likelihood in the receiver.

7. The likelihood calculating method according to claim 1, wherein
likelihoods for two bits of three bits which are successive in the first signal point are calculated, and a larger one of the likelihoods for the two bits is applied as a likelihood for the remaining bit of the three bits.

8. The likelihood calculating method according to claim 7, wherein
the transmitter and the receiver communicate using 64QAM.

9. The likelihood calculating method according to claim 2, wherein
likelihoods for two bits among three bits which are successive in the first signal point are calculated, and a larger one of the likelihoods for the two bits is applied as a likelihood for the remaining bit of the three bits.

10. The likelihood calculating method according to claim 9, wherein
the transmitter and the receiver communicate using 64QAM.

11. A likelihood calculating method, which is used in a receiver having information data of plural signal points based on predefined data which consist of plural bits transmitted from a transmitter, comprising:
receiving a reception signal from the transmitter;
selecting a first signal point which, among the plural signal points, is the shortest distance from the reception signal in a phase plane;
calculating a square of a first distance in the phase plane between the first signal point and the reception signal, and calculating a square of a second distance in the phase plane between a second signal point corresponding to a signal obtained by inverting one of bits of the first signal point and the reception signal; and
calculating the difference between the square of the first distance and the square of the second distance and using the result of calculation as a likelihood of the bit in the reception signal.

12. A likelihood calculating method, which uses a receiver having information data of plural signal points based on predefined data which consist of plural bits transmitted from a transmitter and the receiver comprising a first and a second reception antennas, comprising:
receiving reception signals from the transmitter by each of the first and second reception antennas;
selecting a first signal point which, among the plural signal points, has the smallest sum of a distance from a reception signal of the first reception antenna in the phase plane and a distance from a reception signal of the second reception antenna in the phase plane, with respect to each of the first and second reception antennas;
calculating a first distance sum of the distance in the phase plane between the reception signal of the first reception antenna and the first signal point, and the distance in the phase plane between the reception signal of the second reception antenna and the first signal point;
calculating a second distance sum of the distance in the phase plane between a second signal point corresponding to a signal obtained by inverting one of bits of the first signal point and the reception signal of the first reception antenna, and the distance in the phase plane between the second signal point and the reception signal of the second reception antenna; and
calculating the difference between the first and second distance sums and using the result of calculation as a likelihood indicative of certainty of the bit in the reception signal.

13. The likelihood calculating method according to claim 12, wherein
the first signal point is selected by using a suboptimum decoding algorithm.

14. The likelihood calculating method according to claim 12, wherein
a likelihood is calculated for each bit included in the first signal point.

15. A likelihood calculating method, which uses a receiver having information data of plural signal points based on predefined data which consist of plural bits transmitted from a transmitter and the receiver comprising a first and a second reception antennas, comprising:
receiving reception signals from the transmitter by each of the first and second reception antennas;
selecting a first signal point which, among the plural signal points, has the smallest sum of a square of a distance from a reception signal of the first reception antenna in the phase plane and a square of a distance from a reception signal of the second reception antenna in the phase plane, with respect to each of the first and second reception antennas;
calculating a first sum of the square of the distance in the phase plane between the reception signal of the first reception antenna and the first signal point, and the square of the distance in the phase plane between the reception signal of the second reception antenna and the first signal point;
calculating a second sum of the square of the distance in the phase plane between a second signal point corresponding to a signal obtained by inverting one of bits of the first signal point and the reception signal of the first reception antenna, and the square of the distance in the phase plane between the second signal point and the reception signal of the second reception antenna; and
calculating the difference between the first and second sums and using the result of calculation as a likelihood indicative of certainty of the bit in the reception signal.

16. A likelihood calculating method, which uses a receiver having information data of plural signal points based on predefined data which consist of plural bits transmitted from a transmitter, comprising:
receiving a reception signal from the transmitter;
selecting a first signal point which, among the plural signal points, is the shortest distance from the reception signal in a phase plane;
calculating a first distance in the phase plane between the first signal point and the reception signal, and calculating a second distance in the phase plane between a second signal point corresponding to a signal obtained by inverting one of bits of the first signal point and the reception signal;
calculating the difference between the first and second distances and using the result of calculation as a likelihood indicative of certainty of the bit in the reception signal; and
changing one or more of a transmission power, a modulating method and a coding rate of the transmitter on the basis of an average of the likelihoods of the bits of the reception signal.
